(19) United States
(12) Patent Application Publication
(10) Pub. No.: US 2014/0188917 A1
(43) Pub. Date: Jul. 3, 2014

(54) DIGITAL MODEL FOR STORING AND DISSEMINATING KNOWLEDGE CONTAINED IN SPECIFICATION DOCUMENTS

(71) Applicants: RUPERT HOPKINS, MILLER PLACE, NY (US); DAVID WINCHELL, ROCKY POINT, NY (US); LOUIS ROBERT POKORNY, CALVERTON, NY (US); DAVID S. WARREN, STONY BROOK, NY (US)

(72) Inventors: RUPERT HOPKINS, MILLER PLACE, NY (US); DAVID WINCHELL, ROCKY POINT, NY (US); LOUIS ROBERT POKORNY, CALVERTON, NY (US); DAVID S. WARREN, STONY BROOK, NY (US)

(21) Appl. No.: 13/795,140

(22) Filed: Mar. 12, 2013

Related U.S. Application Data
(60) Provisional application No. 61/746,730, filed on Dec. 28, 2012.

(51) Int. Cl. G06F 17/30

(52) U.S. Cl. CPC G06F 17/30569
USPC 707/756

(57) ABSTRACT

A system for storing and disseminating knowledge contained in documents includes a document annotator that creates a structured syntactic textual model of each of the documents, an ontology directed extractor that extracts properties from the textual models, a database for storing the textual models and the properties, and an interface permitting queries to the database. The document annotator includes a plurality of data transformers and a plurality of custom annotator tools. The ontology directed extractor includes an ontology based schema definition and a plurality of ontology based data transformers. The interface includes a plurality of XSLT style sheets selectable according to context.

### CROSS-REFERENCE TO RELATED APPLICATIONS

This application claims the benefits of provisional application No. 61746730, filed Dec. 28, 2012, entitled A DIGITAL MODEL FOR STORING AND DISSEMINATING KNOWLEDGE CONTAINED IN SPECIFICATION DOCUMENTS.

This application is related to co-owned U.S. Pat. No. 7,542,958 issued Jun. 2, 2009, entitled “Methods for Determining the Similarity of Content and Structuring Unstructured Content from Heterogenous Sources”, the complete disclosure of which is hereby incorporated by reference herein.

### BACKGROUND OF THE INVENTION

1. Field of the Invention

This invention relates broadly to methods and apparatus for mining data and reorganizing it. More particularly, this invention relates to acquiring data from “specification documents” (or other documents) and organizing the data in a readily searchable and accessible database.

2. State of the Art

Standard specifications are published by various agencies and organizations around the world, including ASTM (American Society for Testing and Materials), ANSI (American National Standards Institute), ISO (International Organization for Standardization), etc. Design engineers use these standard specifications when choosing parts and components of products.

Standards are typically published as documents, e.g. Adobe PDF or MS Word documents which are cumbersome to access. Finding specific information in a collection of these documents can be difficult. For example, an initial keyword search of the ASTM specification library based on the keywords STEEL, HEX, and BOLT produces a set of 71 specification documents. A preliminary review of the titles of these 71 documents reveals that: 16 of these documents describe properties of specific types of threaded steel fasteners where bolts were included in the scope of the document. Another 13 documents address testing, inspection, or installation procedures for bolts and are often referenced by the previous 16. The remaining 42 documents are for nonferrous fasteners, threaded fasteners that are not bolts, or procedural specifications such as “Standard Specification for Construction of Fire and Foam Station Cabinets,” where the search keywords are only incidental to the scope of the specification document.

### SUMMARY OF THE INVENTION

The object of the invention is to convert standards specifications from documents into an ontology based digital model (OBDM). Thus, the knowledge contained in a specification is reorganized into a structure that allows automated dissemination of that knowledge in response to user needs. Therefore, the invention also provides an interface to query the ontology via a database. The interface may be a human user interface or a machine-to-machine interface.

The first step in creating an ODBM is to extract a digital structured syntactic textual model of the document from the original PDF, MS Word, or other document format. This syntactic model is expressed as an RDF (Resource Description Framework) database which contains structured information on document sections, tables, cross-references, and other syntactic elements. An ontology directed extractor is then used to analyze the textual portions of the document (e.g. titles, paragraphs, tables, etc.) to extract semantic properties of the digital model to be stored in the database. For retrieval of the model data, an XML (extensible markup language) representation of the digital model is created in response to user queries. An XLST (extensible stylesheet language transformations) style sheet can be used to interpret and display information from the model for the user's context (query).

The tool used to extract the initial syntactic model from the original document includes a plurality of annotators and data transformers. A text converter reads the text from the specification document while preserving the text font, size, and positioning information. The information is then used to recognize sections, tables, and other structural components of the document. The syntactic information is then saved as an XML file. Using the XML file, another program generates RDF “triples” containing facts about the document structure which can then be stored in a database and queried.

The contents of the database are then subjected to ontology directed extraction. This process includes a combination of data transformation, ontology based knowledge processing, and ontology based schema definition. The ontology based schema definition includes a specification ontology defining the meaning of components that make up a specification document. The definition controls the extractor which extracts and transforms data from the syntactic data store by identifying sections of text as class or attribute references, classifying class references to specific class objects in an ontology, and extracting and standardizing attribute references to object attributes using the class of the object for the context of extraction. The transformed data is stored in a database of class objects making up the digital specification models. The three basic classes of information that are stored are Subjects, Requirements, and Governing Authorities.

The user interface is preferably a web-based interface and relies on XML and XSLT. The user submits a query which includes a specification and a context. The context is used to select a particular XSLT style sheet that will be used to display the results of the query. The specification request and context are used to generate a query to the database for specific components of the digital model. The digital model components returned by the query are translated into an XML document which is displayed using the selected style sheet.

The context and style sheets allow a designer to see the specification information required for selecting a part in the context of design constraints, a maintenance engineer to see the procedures necessary to repair or replace an item covered by the specification, and a purchasing manager to see a view of information necessary to order a part that met the specification requirements. Queries can be based on part properties or on part numbers.

In the case of a machine-to-machine interface, existing tools such as XML can be used.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level schematic overview of a system according to the invention;

FIG. 2 is a high level schematic overview of a PDF document annotator according to the invention;

FIG. 2A is a view similar to FIG. 2 but showing a “document converter” in lieu pof the “annotator described in FIG. 2;

FIG. 3 is a high level schematic overview of an ontology directed extractor according to the invention;

FIG. 3A is a view similar to FIG. 3 but showing the extractor utilizing the RDF data provided by the converter of FIG. 2A;

FIG. 4 is a high level schematic over view of a user interface according to the invention;

FIG. 5 is a screen shot of a portion of a technical document;

FIG. 6 is a screen shot of a portion of the annotated text file corresponding to the document of FIG. 5;

FIGS. 7 through 10 are screen shots of portions of a specification document;

FIG. 11 is a flow chart illustration of the text extraction and annotation process; and

FIG. 12 is a diagram of a portion of an OBDM.

### DETAILED DESCRIPTION

The ontology framework according to the invention provides a structure that can be used to represent all information in specifications. The ontology contains three major types of classes of objects: 1. Governing Authorities, 2. Subjects, and 3. Requirements.

Governing Authorities include all documents, specifications, rules, regulations, bodies, etc. that provide authoritative guiding information. The most common example of a governing authority is a specification document. A governing authority is thought of as a set of numbered statements, or assertions, the assertions made by the authority, i.e., those appearing in the document. So a specification document is thought of as the set of sentences in the document. A section of a specification document is the set of sentences in the section, and so is a subset of the full specification. A paragraph in a section is a subset of the sentences in that section. So there is a taxonomy of governing authorities based on the sentences in the authority; the node for a section of a specification is a child of the node for the specification, and a node of a paragraph is a child of the node for the section it is in. A property of this taxonomy is that any assertion made in a node is also made in its parent node. E.g. any assertion made in a paragraph is made in the section containing that paragraph. Examples of a governing authority include MIL-C (Military Specification-C) and ASTM (American Society for Testing and Materials).

Subjects are the objects that are described or defined by a governing authority. For example, if a specification describes circuit breakers, then the set of circuit breakers is the subject of that specification. Many specifications describe parts, and so classes of parts are in the subject taxonomy. Specifications may also describe materials, or tests, or processes, so sets of these things would also appear in the subject taxonomy. The subject taxonomy is structured by subset: e.g., a node representing a set of parts is a child of a node representing a superset of those parts. Subjects may include attributes such as: component structure, parts, materials, manufacturing process, ordering process, packaging process, regulations, test methods.

Requirements represent the constraints that a governing authority asserts that their subjects must satisfy. For example, a circuit breaker specification may say that a particular class of circuit breakers must be able to operate at temperatures between −50 and +80 degrees Celsius. This property is a requirement. One can think of a requirement as being the set of all things that satisfy that property. So the property of “being able to operate at temperatures between −50 and +80 degrees Celsius” can be thought of a representing the set of all things that can operate in that temperature range. Requirements may include attributes such as: component requirements, manufacturing requirements, ordering requirements, packaging requirements, regulatory requirements, testing requirements.

In order to represent specification knowledge fully, it is desirable to specify relationships among the concepts of 1. Governing Authorities, 2. Subjects, and 3. Requirements. This is advantageously done by adding attributes (or properties or relationships) for classes and the elements in the classes. For example, it may be able to say that a set of parts is governed by some part of a specification document. One can do this with a “governedBy” attribute that maps subjects to governing authorities. A particular class of subjects is governed by a particular section of a document, or perhaps a whole document. For example, there is a particular class of circuit breakers that are the subject of the specification MIL-C-55629, so that class has a “governed By” attribute with the value of MIL-C-55629.

Particular requirements are specified by sections (or paragraphs, or sentences) within documents. This is captured by an attribute of requirements, called “describedIn”, whose value is the particular governing authority (spec, section, paragraph, or whatever) in which that requirement is described. For example Paragraph 3 of Section 5.2 of specification MIL-C-55629 might describe the requirement that the subject must be able to operate in a temperature range of −50 to +80 degrees Celsius. So this knowledge would be represented by a “describedln” attribute mapping that temperature requirements node in the requirements taxonomy to that paragraph/section of MIL-C-55629 is the governing authority taxonomy.

It is also desirable to capture the information that a particular set of subjects meets a particular requirement, e.g. that a particular set of circuit breakers actually meets the requirement of being able to operate in the specific temperature range. This can be done with a “meets” attribute, which maps a class in the subject taxonomy to a requirement. (saying that all the parts in a subject class meet the requirements specified by a requirements class is the same as saying that the subject class is a subclass of the requirements class; that is, the set of objects in the subject class is a subset of all the objects that satisfy the requirement.)

The following example shows how the information concerning the operating temperature range of circuit breakers would be represented in an ontology according to the invention. The three taxonomies of the ontology are the Governing Authorities, the Subjects, and the Requirements. In this case the hasOpTemp attribute (for has-operating-temperature) is used to define the desired temperature range. The set of these attributes is somewhat open ended and will depend on the form of requirements specified in the governing document. But note that the only connections from the Subject taxonomy to the Governing Authority taxonomy are labeled “governedBy”; the only connections from the Requirement taxonomy to the Governing Authority taxonomy are labeled “describedBy”; and the only connections from the Subject taxonomy to the Requirement taxonomy are labeled “meets”. There may be many differently labeled connections from the Requirement taxonomy to the Subject taxonomy. These will be attributes needed to define the requirements. Preferably, the Subject taxonomy contains all targets of attributes required to define requirements. In the present example, the node that represents all Celsius temperatures greater the −50 degrees is placed in the subject taxonomy. Another example might be that a part be made of a particular alloy of steel, which may be specified using an attribute “isMadeOf” that maps that requirement node to a node representing that particular alloy. That node would be in a taxonomy of materials, which would also be a sub-taxonomy of the Subject taxonomy. This is reasonable since there are specifications that describe properties of materials, and to represent the information in those material specs, the material taxonomy ought to be included in the Subject taxonomy.

There is one other kind of connection, one which goes from the Governing Authority taxonomy back to itself. This connection (attribute) captures the knowledge that some part of a governing document refers to another part of a governing document. For example Section 5.2 of MIL-C-55629 might refer to another specification on materials, such as the ASTM A116 specification. (It might refer to another section within the same document.) The invention uses an attribute named “references” to capture this knowledge.

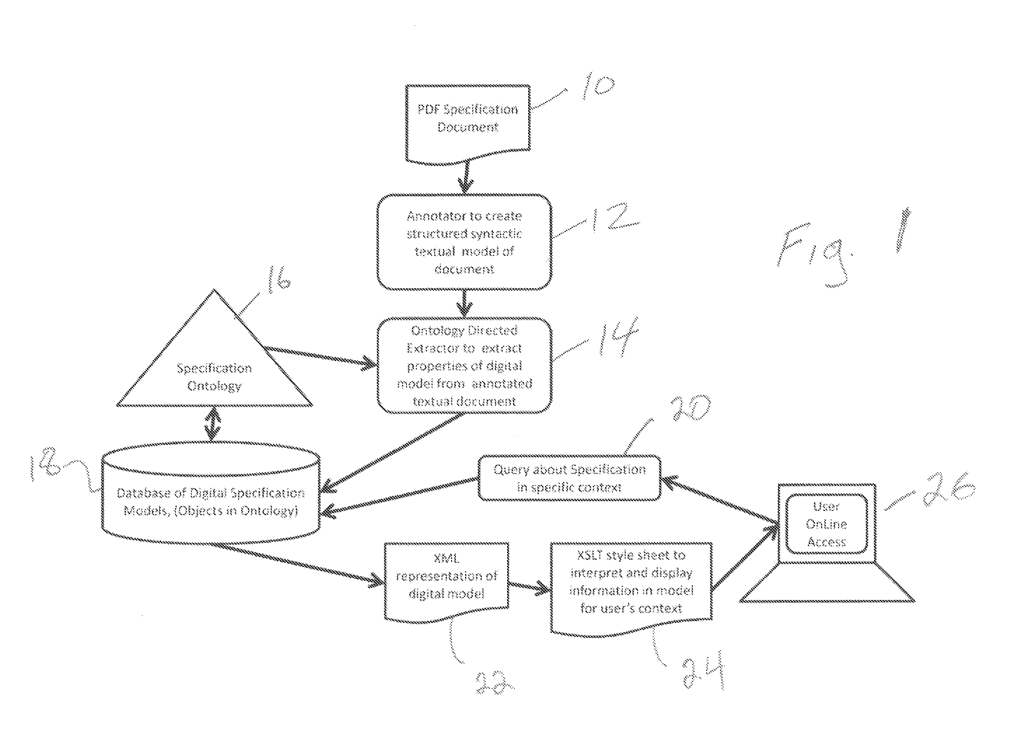

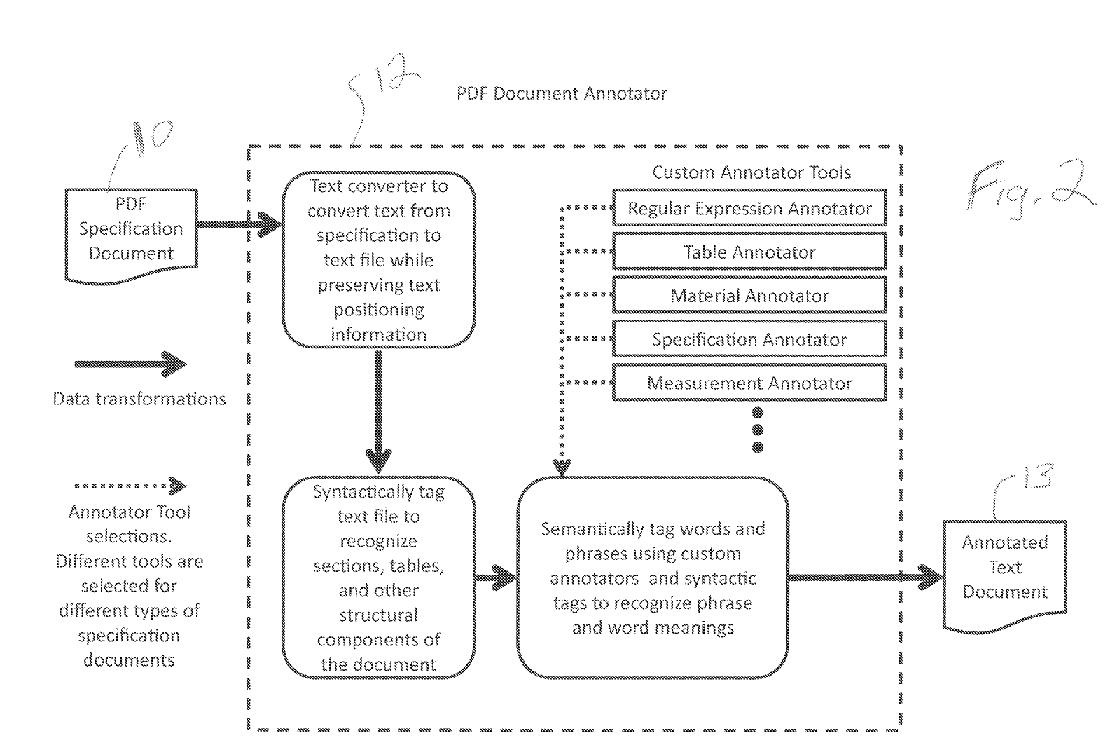

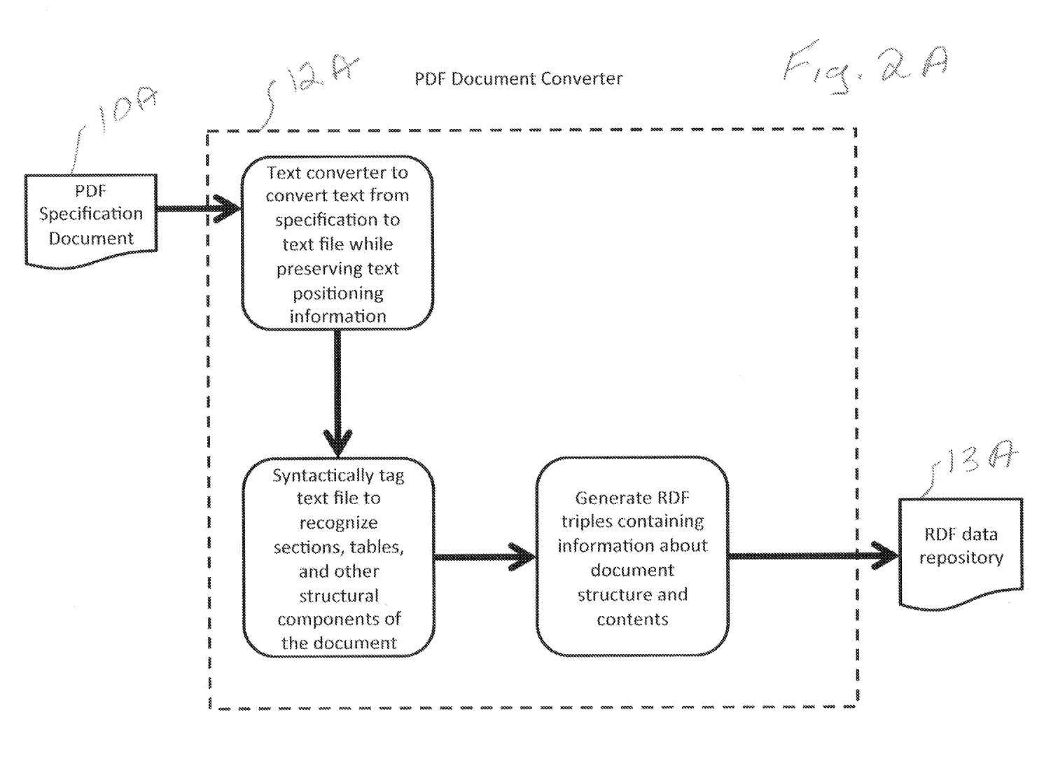

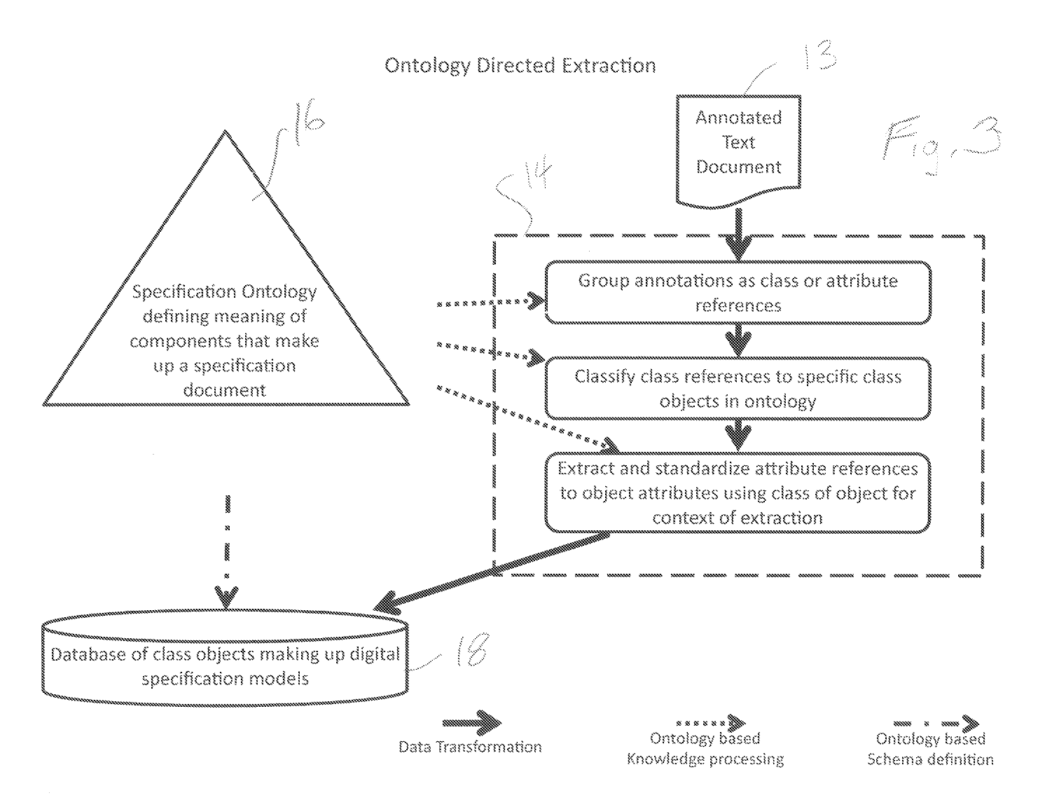

Turning now to FIG. 1, a PDF document 10 is fed to an annotator (alternatively conversion, see FIG. 2A) tool 12 which is used to create a digital structured syntactic textual model of the document. This model is preferably stored as an RDF (see FIGS. 2A and 3A). An ontology directed extractor 14 is then used to extract properties of the digital model based on a specification ontology 16 to be stored in a database 18. An XML representation 22 of the digital model is created in response to user queries 20 from an access point 26 and an XLST style sheet 24 is used to interpret and display information from the model for the user's context (query) at the access point 26. The access point is typically a computer having a keyboard and display but could also be a smart phone or other suitable device. It may be located local to the database or remotely located and communicate with the database via a communications link or network. The access point could also be a program running on a computer that automatically generates queries based on its program logic without the intervention of a human operator. This would be a machine-to-machine implementation.

FIG. 2 illustrates the annotator tool 12 in more detail. The PDF annotator tool 12 includes a plurality of annotators and data transformers. A text converter converts text from the specification document to a text file while preserving the text positioning information. The text file is then syntactically tagged to recognize sections, tables, and other structural components of the document. Words and phrases are then semantically tagged using custom annotators. Annotators may include a regular expression annotator, a table annotator, a material annotator, a measurement annotator, etc. The syntactic tags are then used to recognize word and phrase meanings. The result is an “annotated text document” 13.

Text conversion from PDF to “position preserving” text can be accomplished using a variety of commercially available tools such as the Apache open source PDFBox Java Library, or iText Software's open source Java library called iText. Syntactic tagging of text can be accomplished with custom Java software that makes use of the text position data produced by the PDFBox library. Semantic tagging of text can be accomplished with Apache open source UIMA library. The custom annotators are custom Java annotators integrated into UIMA that either recognize specific semantic patterns or wrap ontology based prolog extraction processes.

FIG. 2A shows an alternate (and presently preferred embodiment) utilizing a “document converter” rather than a “document annotator”. The same PDF specification, here labeled 10A is fed to the converter tool 12A which is used to create a digital structured textual model of the document stored as and RDF data repository 13A. The text conversion and syntactic tagging are the same, but the annotator tools are eliminated and rather than semantic tagging, the converter generates RDF triples containing information about document structure and contents. These are then output to an RDF data repository 13A.

FIG. 3 illustrates more details regarding the ontology directed extractor 14. The annotated text document 13 is subjected to ontology directed extraction 14. This process includes a combination of data transformation, ontology based knowledge processing, and ontology based schema definition. The ontology based schema definition includes a specification ontology 16 defining the meaning of components that make up a specification document. The definition controls the extractor 14 which transforms data from the annotated text document 13 by grouping annotations as class or attribute references, classifying class references to specific class objects in an ontology, and extracting and standardizing attribute references to object attributes using the class of the object for the context of extraction. The transformed data is stored in a database 18 of class objects making up the digital specification models.

The type of annotation (class or attribute) is determined by the type of annotator that created it. The classification of class references is accomplished with the XSB Ontology Directed Classifier. (See U.S. Pat. No. 7,542,958) The extraction of attribute references is accomplished with the XSB Ontology Directed Extractor. (See U.S. Pat. No. 7,542,958) The output of the extraction uses SQL to input objects and their attributes into the database. The Ontology Schema is managed using the XSB CDF Ontology Management framework. (See U.S. Pat. No. 7,542,958.)

FIG. 3A shows an alternate (and presently preferred) embodiment. In FIG. 3A, the specification ontology 16 and database of class objects 18 are the same as in FIG. 3. Here, however, the extraction begins with the RDF Triple Store 13A.

The RDF repository (triple store) 13A contains the original specification document encoded as specific text objects and syntactic relations between these text objects. Each text object is a specific statement, usually at the sentence or table row level, contained in the original document. Syntactic relations between text objects indicate how text objects relate to each other in the document.

Each text object is subjected to ontology directed extraction 14A. This process includes a combination of data transformation, ontology based knowledge processing, and ontology based schema definition. The ontology based schema definition uses a specification ontology 16 to define the meaning of components that make up a specification document. The definition controls the extractor 14A which transforms text objects from the RDF Triple Store 13A by classifying the text object to a subject class in the specification ontology 16 and extracting and standardizing object attributes using the class of the text object for the context of extraction. The transformed text object is stored in a database 18 of class objects with their associated attributes making up the digital specification models. Each class object in the database is thus a representative of the specification ontology class using the ontology based schema definition.

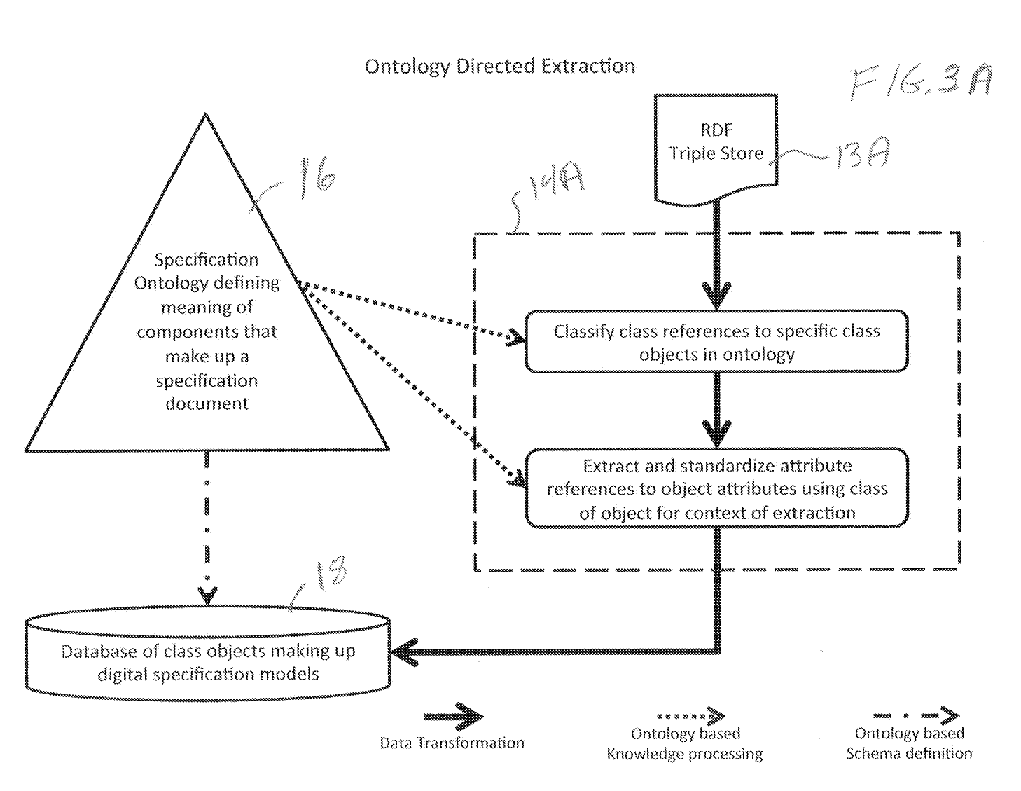

FIG. 4 shows how a user interacts with the system. The user interface is preferably a web-based interface and relies on XML and XSLT. The user submits a query 20 which includes a specification and a context 20a. The specification request and context are used to generate a query 20b to the database 18 for specific components of the digital model. The context is also used to select 20c a particular XSLT style sheet that will be used to display the results of the query. The digital model components returned by the query are translated at 21 into an XML document 22 which is displayed at 24 using the style sheet selected at 20c from a library of style sheets 23.

The queries from users can be implemented as web services called from the user's web browser using the Restful Public Architecture Specification. The specification request to the database is a query triggered by the web service. Context mediation chooses XSLT stylesheets based on context supplied by the web service. Digital model components are the query results translated into XML representations of relevant parts of the specification. The web server uses the selected stylesheet to display the XML representation to the user's browser.

The web service can alternately be called directly by a software program running on a remote machine and will return the XML output directly to the calling program. This implementation of the invention represents a direct machine-to-machine application of the digital specification model.

The context and style sheets allow a designer to see the specification information required for selecting a part in the context of design constraints, a maintenance engineer to see the procedures necessary to repair or replace an item covered by the specification, and a purchasing manager to see a view of information necessary to order a part that met the specification requirements. Queries can be based on part properties or on part numbers.

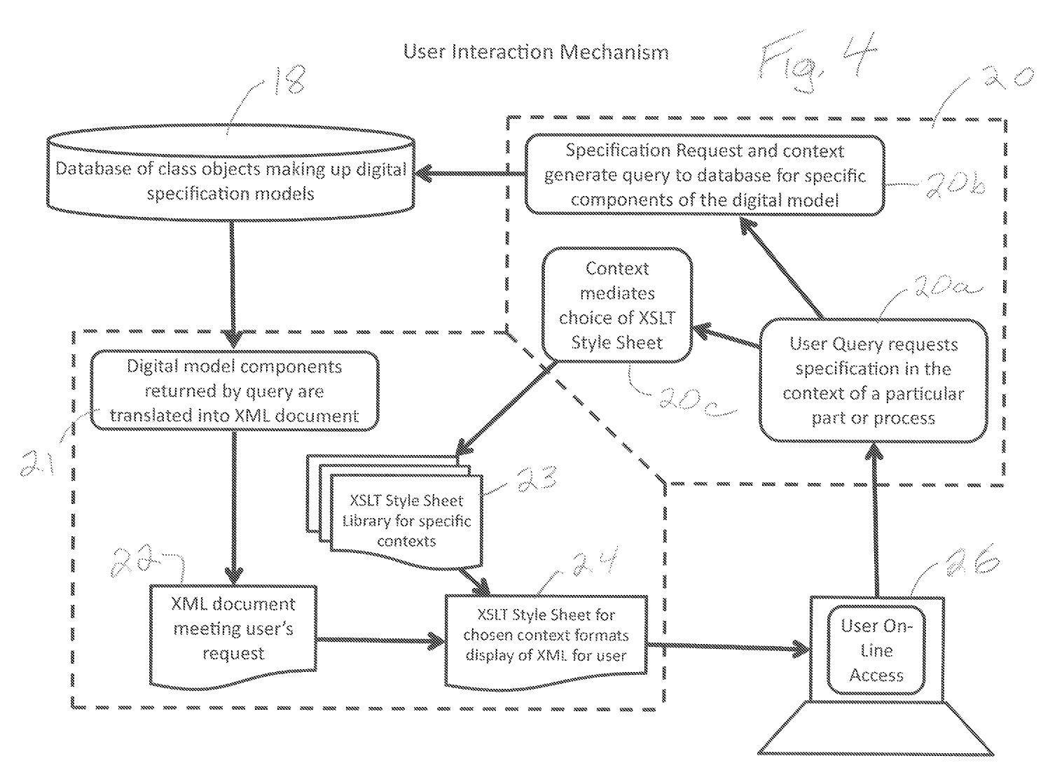

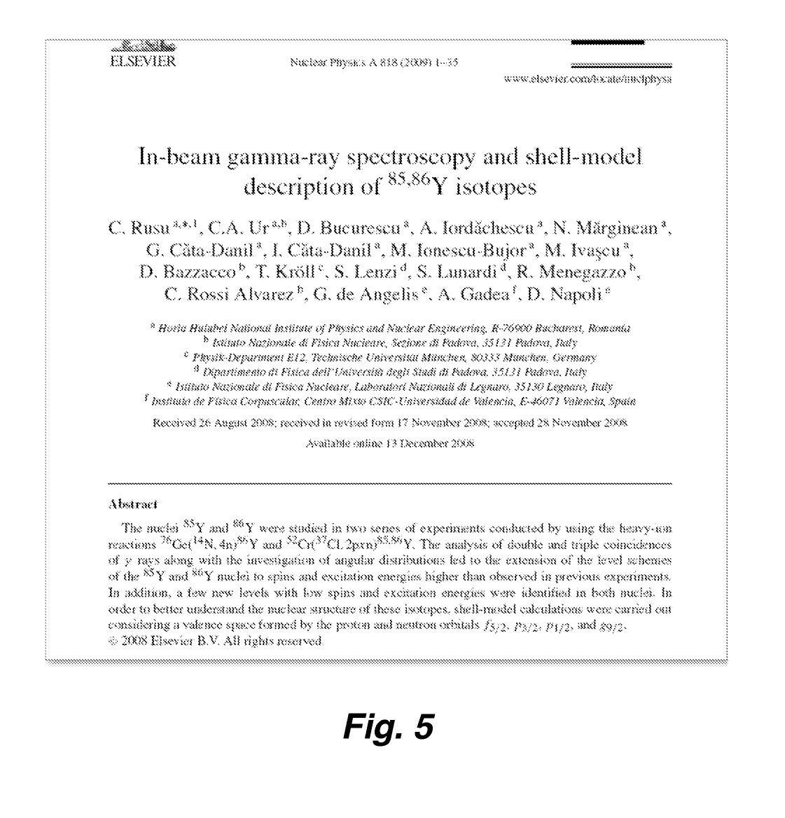

The system and methods of the invention are particularly aimed at specification documents but can also be used to store and disseminate most any kind of knowledge. FIG. 5 shows a portion of a technical paper and FIG. 6 illustrates how that paper is converted into an annotated text document using the methods of the invention. Highlighted portions of the document on the left hand side of FIG. 6 are extracted according to an ontology that includes, in this example, “decay”, “reaction”, “KW”, “nuclide”, etc. These “annotations” are listed in hierarchical format on the right hand side of FIG. 6.

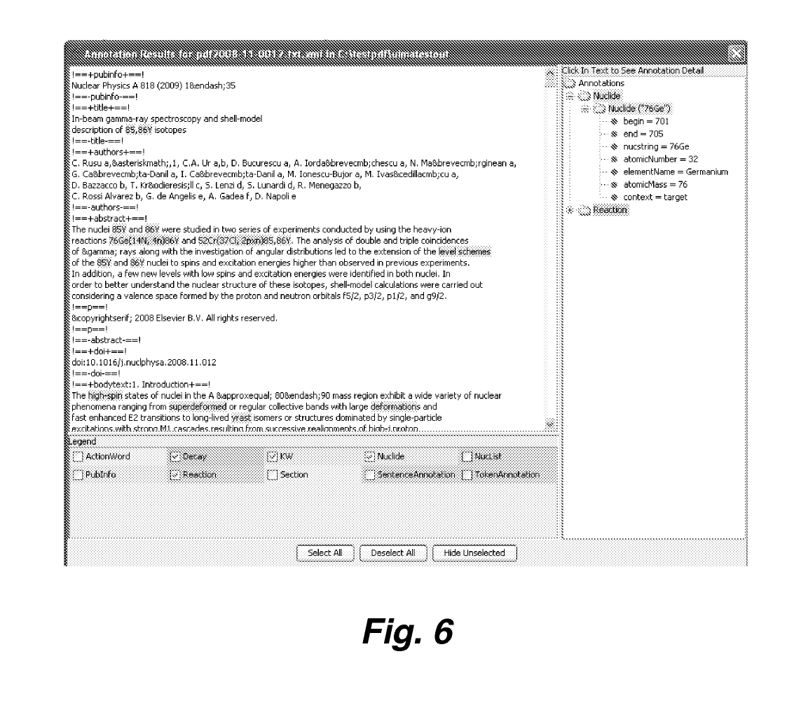

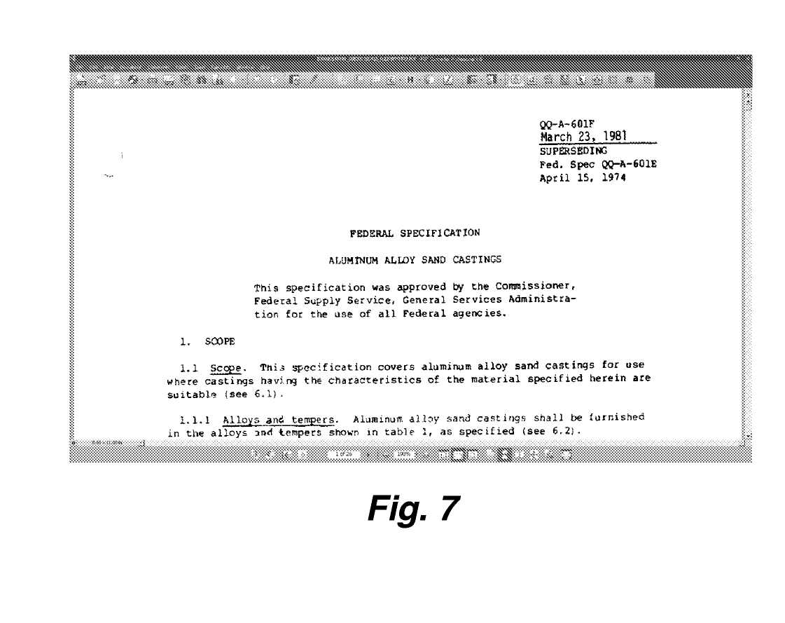

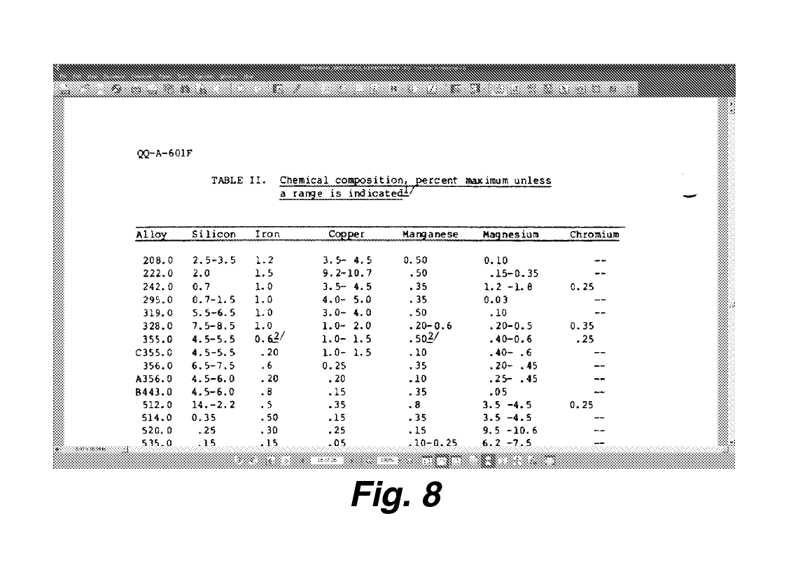

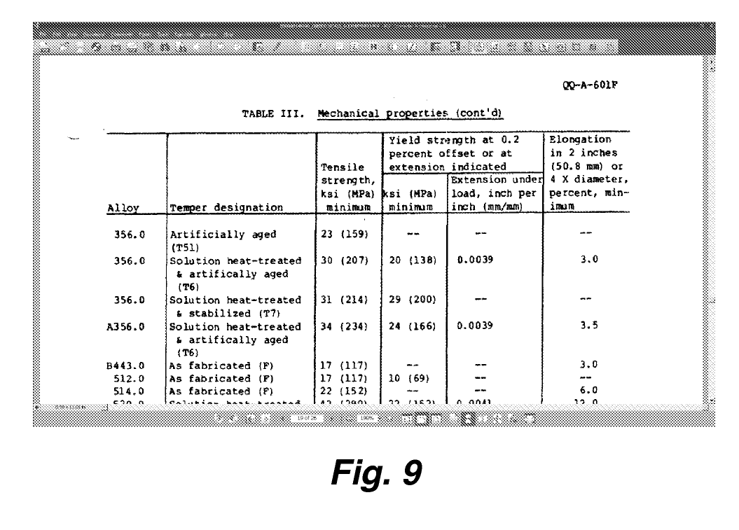

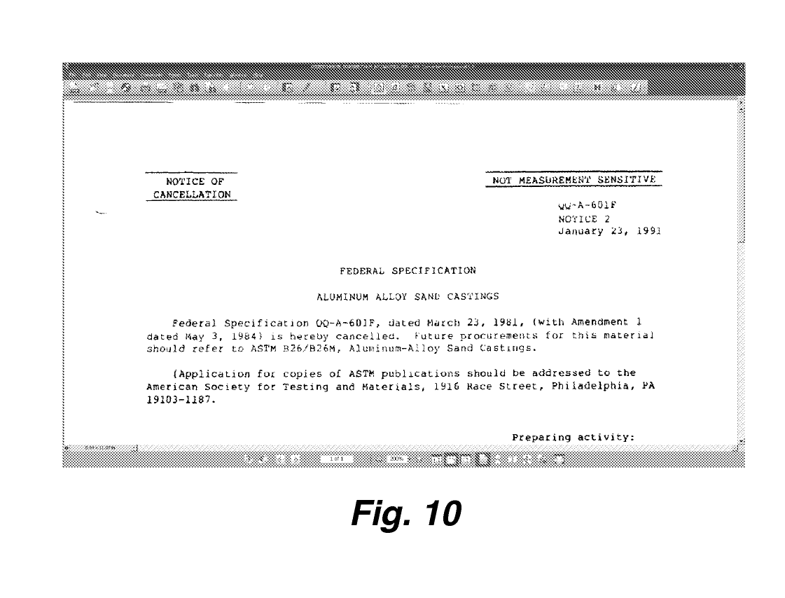

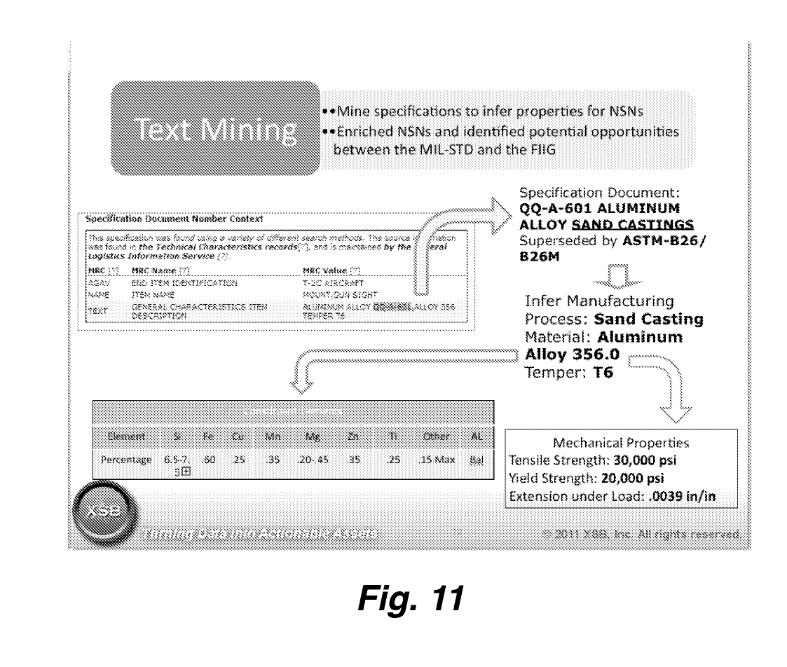

FIGS. 7-10 illustrate portions of Federal Specification QQ-A-601F regarding Aluminum Alloy Sand Castings. FIG. 11 shows how the knowledge from the specification is extracted and converted into an annotated text document. Text is mined to infer properties for a part represented by a Federal National Stock Number (NSN). NSNs are assigned to most items purchased by the US Department of Defense. Properties of NSNs are cataloged as technical characteristics. The properties appropriate for a given type of part are defined in Federal Item Identification Guides (FIIGs). FIG. 11 shows technical characteristics for an NSN corresponding to a Gun Sight Mount. From the TEXT characteristic “GENERAL CHARACTERISTICS ITEM DESCRIPTION” text extraction extracts specification QQ-A-601, Alloy 356.0, and Temper T6. From the title of QQ-A-601 (FIG. 7) it is inferred that the part is Aluminum and a Sand Casting. From Table II in QQ-A-601 (FIG. 8) the chemical composition of Aluminum Alloy 356.0 is inferred. From Table III in QQ-A 601 (FIG. 9) it is inferred that the material, Aluminum Alloy356.0 with temper T6 has mechanical properties, 30,000 psi tensile strength, 20,000 psi yield strength, and 0.0039 in/in extension under load.

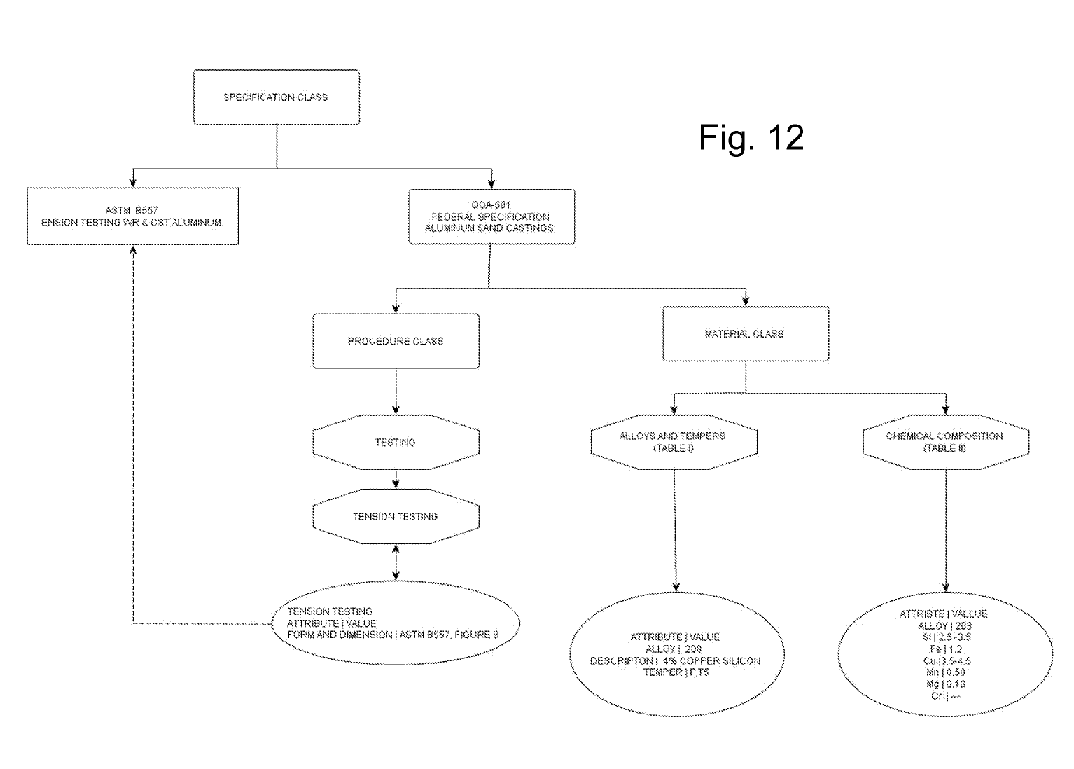

FIG. 12 illustrates how portions of the QQ-A-601 F specification are organized in an OBDM according to the invention. The SPECIFICATION CLASS includes reference to the relevant specifications. In this simplified example, the SPECIFICATION CLASS includes references to external specifications found in the document QQA-601. Here, for simplicity, only one is shown, ASTM B557.

The specification class QQA-601 is subdivided into the PROCEDURE CLASS and the MATERIAL CLASS.

THE PROCEDURE CLASS includes all of the procedures (and processes) in the specification. For simplicity, only the Quality Assurance branch of the model is shown. This branch has several sub-classes. The last sub class is TENSION TESTING; this sub classes references the ASTM specification that is a member of the SPECIFICATION CLASS above. There is a secondary relation between the TENSION TESTING sub class and the ASTM instances in the SPECIFICATION CLASS. Note that these TENSION TESTING instances reference specific figure in the ASTM document. This would be linked data in a semantic technology model.

The MATERIALS CLASS illustrates primary relations that trace directly to tables in the document. The actual cells in the table will be linked data in the semantic model. Here, for simplicity, only portions of two tables are shown: the ALLOYS AND TEMPERS (TABLE I) and the CHEMICAL COMPOSITION (TABLE II). Table I includes three attributes, each having a value, i.e. alloy: 208, description: 4% coppor silicon, temper: F, T5. Table II includes seven attributes, each having a value, i.e. alloy: 208, Si: 2.5-3.5, Fe: 1.2, Cu: 3.5-4.5, Mn: 0.50, Mg: 0.10, Cr: - - - .

The Ontology Based Digital model can be defined using a public domain ontology definition language such as OWL/RDF. The Web Ontology Language (OWL) is a family of knowledge representation languages for authoring ontologies. The languages are characterized by formal semantics and RDF/XML based serializations.

There have been described and illustrated herein several embodiments of a DIGITAL MODEL FOR STORING AND DISSEMINATING KNOWLEDGE CONTAINED IN SPECIFICATION DOCUMENTS. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

1. A system for organizing, storing and disseminating knowledge contained in a collection of documents, said system embodied on a tangible computer readable medium coupled to a processor and comprising:
an ontology that provides a schema to represent the syntax and semantics of the collection of documents;
a document annotator/converter that creates a shared structured syntactic model of the documents;
a ontology directed semantic tagger that creates a shared structured semantic model of the documents;
a database for storing the syntactic and semantic models as objects in the ontology; and
an interface permitting queries to the database.

2. The system according to claim 1, wherein:
said document annotator/converter includes a plurality of data transformers and a plurality of custom annotator tools.

3. The system according to claim 1, wherein:
said interface includes a plurality of XSLT style sheets selectable according to context.

4. The system according to claim 2, wherein:
said data transformers include a text converter to convert text from the document to a text file while preserving text positioning information.

5. The system according to claim 4, wherein:
said data transformers include a syntactical tagger to recognize sections, tables and other structural components of the document.

6. The system according to claim 5, wherein:
said data transformers include a semantical tagger which utilizes syntactic tags and said custom annotator tools to recognize word and phrase meanings.

7. The system according to claim 6, wherein:
said custom annotator tools include one or more of the following tools: a regular expression annotator, a table annotator, a material annotator, a specification annotator, and a measurement annotator.

8. The system according to claim 2, wherein:
said plurality of ontology based data transformers include group annotations as class or attribute references, classifications of specific class objects in the ontology, and extraction and standardization of attribute references to object attributes using class of object for context of extraction.

9. The system according to claim 3, wherein:
said interface accepts queries including context, uses context to search the database and also to select the XLST style sheet to be used to display the results of the query.

10. A method for using an ontology to store and disseminate knowledge contained in a collection of documents, said method embodied on a tangible computer readable medium coupled to a processor comprising:
creating a shared structured syntactic model of the documents;
creating a shared structured semantic model of the documents;
creating a database for storing the syntactic and semantic models as objects in the ontology; and
providing an interface permitting queries to the database.

11. The method according to claim 10, wherein:
said step of creating a shared structured syntactic model includes transforming and annotating.

12. The method according to claim 10, wherein:
said step of creating a database uses an ontology based schema definition and includes a plurality of ontology based data transformations.

13. The method according to claim 10, wherein:
said interface includes a plurality of XSLT style sheets selectable according to context.

14. The method according to claim 11, wherein:
said step of transforming includes converting text from the document to a text file while preserving text positioning information.

15. The method according to claim 14, wherein:
said step of transforming includes syntactical tagging to recognize sections, tables and other structural components of the document.

16. The method according to claim 15, wherein:
said step of transforming includes semantical tagging utilizing syntactic tags and annotator tools to recognize word and phrase meanings.

17. The method according to claim 16, wherein:
said annotator tools include one or more of the following tools: a regular expression annotator, a table annotator, a material annotator, a specification annotator, and a measurement annotator.

18. The method according to claim 12, wherein:
said plurality of ontology based data transformations include group annotations as class or attribute references, classifications of specific class objects in the ontology, and extraction and standardization of attribute references to object attributes using class of object for context of extraction.

19. The method according to claim 13, wherein:
said interface accepts queries including context, uses context to search the database and also to select the XLST style sheet to be used to display the results of the query.

20. A tangible computer readable medium containing program instructions for storing and disseminating knowledge contained in an ontology about a collection of documents, wherein execution of the program instructions by one or more processors of a computer system causes the one or more processors to carry out the steps of:
creating a shared structured syntactic model of the documents;
creating a shared structured semantic model of the documents;
creating a database for storing the syntactic and semantic models as objects in the ontology; and
providing an interface permitting queries to the database.

21. A method for using an ontology to transform, store and disseminate tangible data representing knowledge contained in a collection of documents, said method comprising:
creating a shared structured syntactic model of the tangible data representing the documents;
creating a shared structured semantic model of the tangible data representing the documents; and
creating a tangible database for storing the tangible data representing the syntactic and semantic models as objects in the ontology.

22. The method according to claim 21, further comprising:
providing a tangible interface permitting queries to the database.

23. The method according to claim 21, wherein:
said step of creating a shared structured syntactic model includes transforming and annotating the tangible data representing the documents.

24. The method according to claim 21, wherein:
said step of creating a tangible database uses an ontology based schema definition and includes a plurality of ontology based transformations of tangible data.

25. The method according to claim 22, wherein:
said tangible interface includes a plurality of transformation processes selectable according to context.

26. The method according to claim 23, wherein:
said step of transforming includes converting text from the tangible document to a tangible text file while preserving text positioning information.

27. The method according to claim 23, wherein:
said step of transforming includes syntactical tagging to recognize sections, tables and other structural components of the tangible document.

28. The method according to claim 23, wherein:
said step of transforming includes semantical tagging utilizing syntactic tags and annotator tools to recognize word and phrase meanings.

29. The method according to claim 28, wherein:
said annotator tools include one or more of the following tools: a regular expression annotator, a table annotator, a material annotator, a specification annotator, and a measurement annotator.

30. The method according to claim 24, wherein:
said plurality of ontology based data transformations include group annotations as class or attribute references, classifications of specific class objects in the ontology, and extraction and standardization of attribute references to object attributes using class of object for context of extraction.

31. The method according to claim 22, wherein:
said tangible interface accepts queries including context, uses context to search the database and also to select the transformation process to be used to display the results of the query.
